(19) United States
(12) Patent Application Publication
(10) Pub. No.: US 2012/0248209 A1
(43) Pub. Date: Oct. 4, 2012

(54) HVAC SETBACK SYSTEM

(76) Inventor: Drew Reid, Brentwood, TN (US)

(21) Appl. No.: 13/077,357

(22) Filed: Mar. 31, 2011

(51) Int. Cl. F24F 11/02; G05D 23/19

(52) U.S. Cl. 236/51

(57) ABSTRACT

An actuator for use with an HVAC system in a building having a door includes a thermostat having a setback function, and a wireless switch placed remotely from the thermostat. The switch is for being disposed on or adjacent the door. Upon actuation of the switch, a first signal is sent to the thermostat for placing the HVAC system in a setback condition.

### FIELD OF THE INVENTION

This invention relates to HVAC systems and more particularly to HVAC systems having remote setback activation and deactivation.

### BACKGROUND

HVAC accounts for large amounts of energy consumption in many homes. Although programmable thermostats are available wherein users can program HVAC setbacks to minimize energy consumption, these schedules are often either left unprogrammed or are rigidly programmed to schedules that do not reflect actual fluctuating user schedules.

### SUMMARY

According to an embodiment disclosed herein, an actuator for use with an HVAC system in a building having a door includes a thermostat having a setback function, and a wireless switch placed remotely from the thermostat. The switch is for being disposed on or adjacent the door. Upon actuation of the switch, a first signal is sent to the thermostat for placing the HVAC system in a setback condition.

According to an embodiment disclosed herein, an actuator for use with an HVAC system in a building having a door has a thermostat having a setback function placed centrally in the building, and a wireless switch placed remotely from the thermostat. The switch is disposed on or adjacent the door. Upon actuation of the switch, a first signal is sent to the thermostat for placing the HVAC system in a setback condition.

According to an embodiment disclosed herein, a method for controlling temperature in a building having a door includes the steps of: placing a wireless switch on or adjacent a door remotely from a thermostat that controls an HVAC system, and actuating the switch to send a first signal to the thermostat for placing the HVAC system in a setback condition.

These and other features of the present invention can be best understood from the following specification and drawings, the following of which is a brief description.

### BRIEF DESCRIPTION OF THE DRAWINGS

FIG. 1 a perspective view of a house employing an embodiment described herein;

FIG. 2 is a cutaway perspective view of a switch of FIG. 1; and

FIG. 3 describes a method of utilizing the embodiment of FIG. 1.

### DETAILED DESCRIPTION OF THE PREFERRED EMBODIMENT

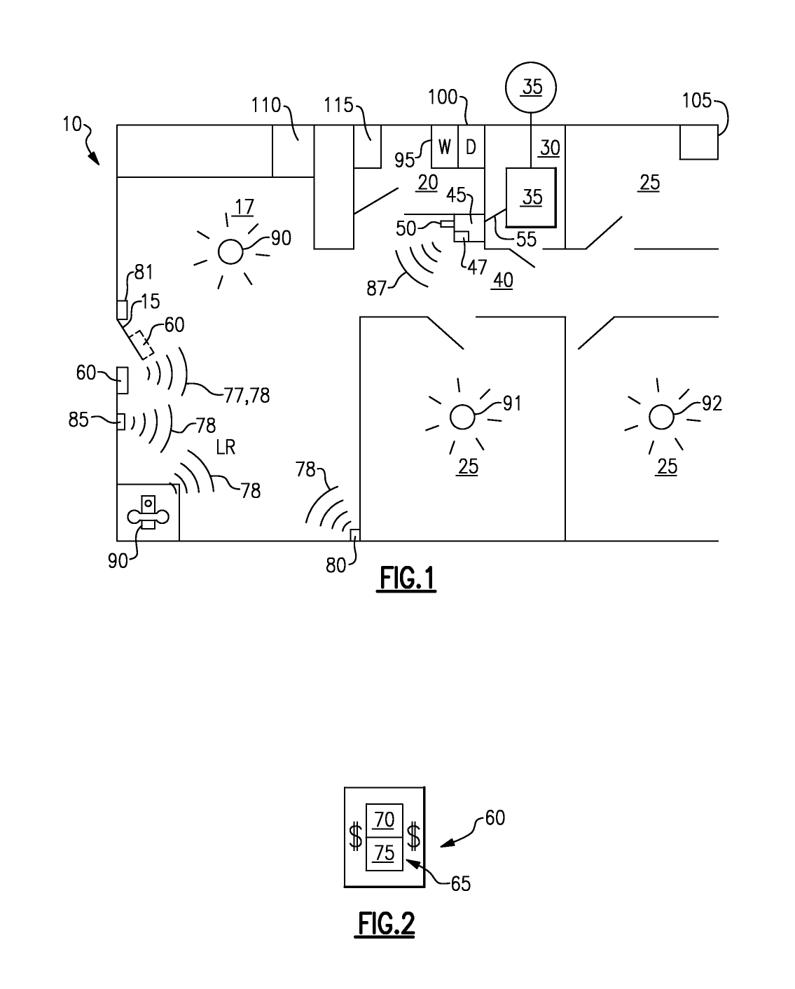

Referring to FIG. 1, an embodiment of a building 10, such as a house, is shown. The house has a door 15 through which a user may enter and exit the building 10, a kitchen 17, a bathroom 20, three bedrooms 25, a utility room 30 in which an HVAC system 35 is disposed and a hallway 40. A programmable thermostat 45, which has an antenna 50 for receiving signals as will be discussed infra, is disposed in the hallway 40. The thermostat 45 is either hardwired via wire 55 to the HVAC system 35 or has a RF link therewith. The thermostat 45 has a setback function/power controller 47 therein which may be programmable, button actuated or signal actuated.

The thermostat 45 is placed, typically in a hallway 40, away from the door 15 so that air passing through the door 15 does not adversely affect the thermostat and therefore the temperature of the building 10.

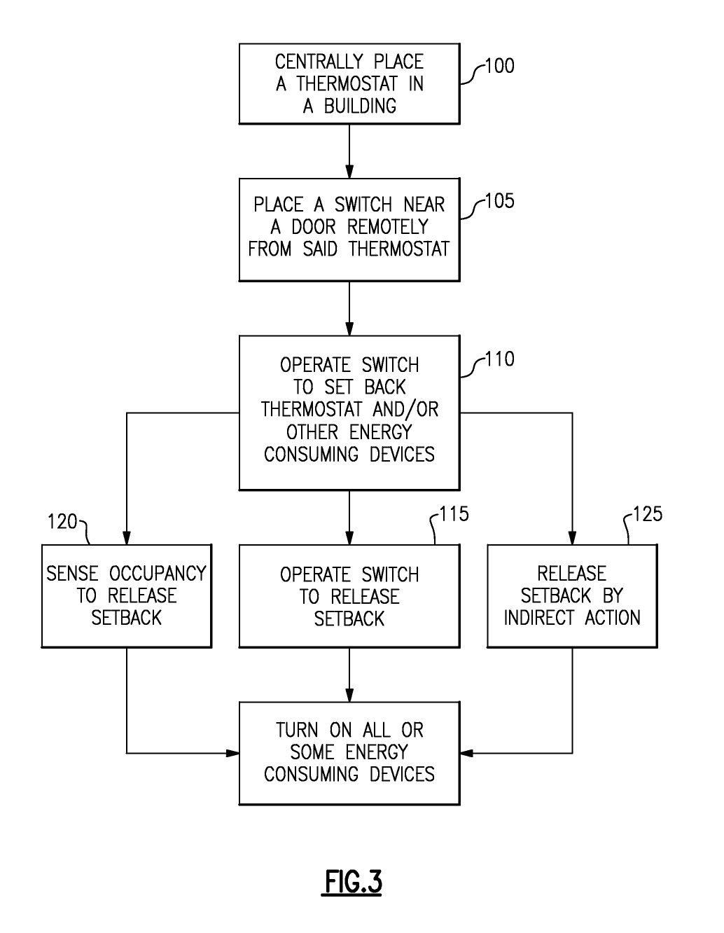

A RF battery-less wireless switch 60, which may be acquired by Verve Living Systems of Winston-Salem, N.C., and see also FIG. 2, is placed in close proximity to the door 15. The switch 60 has a rocker 65 with a top portion 70 and a bottom portion 75 and may be painted or decorated in a manner (e.g. a garish color, green or dollar signs) to give a user a visual cue to use the switch.

As an example, the bottom portion 75 may be pushed by a user if leaving the building 10 to send a first signal 77 to the thermostat 45 that is received via antenna 50 to have the thermostat put the HVAC system 35 in a setback condition. A “setback” means a lower temperature in a heating season and a higher temperature in a cooling season. The switch 60 sends an HVAC signal and does not couple that signal with a security signal. The thermostat 45 maintains the HVAC system 35 in the setback condition until the user returns and pushes the top portion 70 to send a second signal 78 (which may be the same as the first signal) to release the HVAC system 35 from the setback condition. At this point, the thermostat 45 operates in a normal mode which, if the thermostat 45 is programmable, could still be setback. For instance, if a user returns late at night in a heating season, the temperature of the building 10 is more likely to be setback to aid sleeping. The thermostat 45 may also reset to the previously set temperature before the setback condition was actuated by the switch 60.

Though the switch 60 is shown with a rocker 65, other types of switches are contemplated and could be button, or the like, operated. For instance, a button (not shown) may be pressed once to get a setback condition or twice to be released from a setback condition.

The system may be released from the setback condition by passive actuation. For instance, a battery-less wireless occupancy sensor 80, which may be acquired by Verve Living Systems of Winston-Salem, N.C., sends a signal 78 to the thermostat 45 to release the HVAC system 35 from the setback condition if occupancy is sensed. The sensor 80 may be placed where reentry into the building 10 is likely to be sensed. Similarly, a contact switch 81 that may be impacted by the door 15 may be used to send a signal to the thermostat 45 to release the setback. This signal from the contact switch may not be implemented by the thermostat for a period of time to allow for reentry for a period of time if, for instance, a user has forgotten something or a child is hurrying to get out. By not requiring a user who reenters the building 10 to take action, the user whose hands are full or who forgets to activate the switch 60, removes the building 10 from the setback condition without requiring conscious effort.

The user may also indirectly release the HVAC system from setback condition by indirect means such as activating a device such as a light switch 85 which sends a signal 78 to the thermostat 45 or using a telephone 90 that sends a signal 78 upon use, or the like.

The thermostat may choose not to release the HVAC system for a period of time, for instance 60-90 seconds after activating the setback condition, to give a user time to exit the building 10. Similarly the thermostat may choose not to enter the setback condition after the switch 60 is activated for a period of time, for instance 60-90 seconds after sensing no activity, to allow a user to reenter the building 10.

By placing the switch 60 adjacent a door 15 that is commonly used, a user will be reminded by the visual cue of the switch 60 to setback the temperature of the building 10 to save money and resources. The user does not have to remember to travel to the thermostat 45 to setback the temperature of the building 10. Similarly, the user does not have to go to the thermostat 45 to release the setback when returning to the building 10 because the switch 65 is right adjacent or on the door 15. The building 10 may have more switches 60 therein particularly if there are more doors 15.

Referring to FIG. 3, a method of using the embodiment described herein is shown. In step 100, a thermostat 45 is place centrally within a building 10. In step 105, a wireless, battery-less switch 60 is placed adjacent or on a door 15. In step 110, the switch 60 is operated to send a signal to the thermostat 46 to place the HVAC system 35 in a setback condition. In step 115, the switch 60 is operated (providing active input by the user) to send a signal to the thermostat 46 to release the HVAC system 35 from the setback condition, or, in step 120, the setback condition is released if occupancy is sensed without active input by the user, or, in step 125 the setback condition is released by indirect action by operating another device, such as switch 85, telephone 90, or the like.

Though an HVAC system is disclosed herein, the set back/power controller 47 may send a signal 87 to shut off other loads like lights 90, 91, 92, washer 95, driers 100, TVs or computers 105 or the like, dishwashers 110, water heaters 115 or other appliances that use power, like electricity, gas or oil, and/or may have vampire loads. The set back/power controller 47 may be programmable to turn back only the loads that are desired by the user, like a light 90 or the water heater 115 while leaving other devices like the TV 105 or the washer off.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An actuator for use with an HVAC system in a building having a door comprising:
a thermostat having a setback function, and
a wireless switch placed remotely from said thermostat, said switch for being disposed on or adjacent said door, and wherein upon actuation of said switch a first signal is sent to said thermostat for placing said HVAC system in a setback condition.

2. The actuator of claim 1 wherein said switch is battery-less.

3. The actuator of claim 1 wherein said switch does not send a security signal.

4. The actuator of claim 1 wherein said switch provides a visual cue to a user to use said switch if adjacent said door.

5. The actuator of claim 4 wherein said visual cue is a decoration.

6. The actuator of claim 1 wherein said actuator is for being placed on said door.

7. The actuator of claim 1 wherein upon actuation of said switch, a second signal is sent to said thermostat for releasing said HVAC system from said setback condition.

8. The actuator of claim 7 wherein said switch further comprises a second switch.

9. The actuator of claim 8 wherein said second switch is a contact switch placed upon a door.

10. The actuator of claim 1, whereupon actuation of a sensor, a second signal is sent to said thermostat for releasing said HVAC system from said setback condition.

11. The actuator of claim 1, whereupon actuation of a device, said thermostat is configured to send a second signal for releasing said HVAC system from said setback condition.

12. The actuator of claim 1 wherein a controller is configured to shut off other consumers of power in conjunction with setting back the HVAC system.

13. The actuator of claim 12 wherein said controller is configured to turn back on selected of said other consumers of power in conjunction with releasing said HVAC system from said setback condition.

14. The actuator of claim 1 wherein a controller is configured to receive a second signal to release said setback condition.

15. An actuator for use with an HVAC system in a building having a door comprising:
a thermostat having a setback function disposed in said building, and
a wireless switch placed remotely from said thermostat, said switch being disposed on or adjacent said door, and wherein upon actuation of said switch a first signal is sent to said thermostat for placing said HVAC system in a setback condition.

16. The actuator of claim 15 wherein said switch is battery-less.

17. The actuator of claim 15 wherein said switch does not send a security signal.

18. The actuator of claim 15 wherein said switch provides a visual cue to a user to use said switch if adjacent said door.

19. The actuator of claim 15 wherein upon actuation of said switch, a second signal is sent to said thermostat is configured to release said HVAC system from said setback condition.

20. The actuator of claim 15 wherein said switch comprises a second switch.

21. The actuator of claim 15, whereupon actuation of a sensor, a second signal is sent to said thermostat that is configured to release said HVAC system from said setback condition.

22. The actuator of claim 15, whereupon actuation of a device, a second signal is sent to said thermostat for releasing said HVAC system from said setback condition.

23. The actuator of claim 15 wherein a controller is configured to shut off a consumer of power in conjunction with setting back the HVAC system.

24. The actuator of claim 23 wherein said controller is configured to turn back on selected of other consumers of power in conjunction with releasing said HVAC system from said setback condition.

25. The actuator of claim 15 wherein a controller is configured to receive a second signal to release said setback condition

26. A method for controlling temperature in a building having a door comprising the steps of:
placing a wireless switch on or adjacent a door remotely from a thermostat that controls an HVAC system,
actuating said switch to send a first signal to said thermostat for placing said HVAC system in a setback condition.

27. The method of claim 25 further comprising:
delaying entering said system in a setback condition for a period of time after actuating said switch.

28. The method of claim 25 further comprising;
actuating said switch to send a second signal to said thermostat to release said HVAC system from said setback condition.

29. The method of claim 25 further comprising:
delaying removing said system from said setback condition for a period of time after actuating said switch to send a second signal.

30. The method of claim 25 further comprising:
providing a visual cue that said switch is adjacent said door to encourage a user to notice and use said switch.

31. The method of claim 25 further comprising:
sending a second signal upon sensing occupancy to release said HVAC system from said setback condition.

32. The method of claim 31 further comprising:
delaying removing said system from said setback condition for a period of time after sending said second signal.

33. The method of claim 26 further comprising:
sending a second signal upon user activation of a device to release said HVAC system from said setback condition.

34. The method of claim 33 further comprising:
delaying removing said system from said setback condition for a period of time after sending said second signal.

35. The method of claim 26 wherein a controller shuts off a consumer of power in conjunction with setting back the HVAC system.

36. The method of claim 35 wherein said controller is turns back on selected of consumers of power in conjunction with releasing said HVAC system from said setback condition.

37. The method of claim 26 wherein a controller is configured to receive a second signal to release said setback condition.
